(19) United States
(12) Patent Application Publication
(10) Pub. No.: US 2026/0226284 A1
(43) Pub. Date: Aug. 6, 2026

(54) SURFACE-TREATED STEEL SHEET

(71) Applicant: NIPPON STEEL CORPORATION, Tokyo (JP)

(72) Inventors: Minae NISHIKADO, Tokyo (JP); Shin UENO, Tokyo (JP); Yoshikatsu NISHIDA, Tokyo (JP)

(73) Assignee: NIPPON STEEL CORPORATION, Tokyo (JP)

(21) Appl. No.: 19/149,878

(22) PCT Filed: Feb. 1, 2024
(86) PCT No.: PCT/JP2024/003293

§ 371 Date: Jul. 22, 2025

(30) Foreign Application Priority Data
Feb. 1, 2023 (JP) 2023-013875

(51) Int. Cl. C09D 5/08; C08K 9/02; C09D 7/40; C09D 7/62; C23F 11/173

(52) U.S. Cl. CPC C09D 5/084; C09D 7/62; C09D 7/69; C09D 7/70; C23F 11/173; C08K 9/02; C08K 2201/005

(57) ABSTRACT

A surface-treated steel sheet includes: a galva-annealed steel sheet and a galva-annealed layer on the steel sheet. The galva-annealed steel sheet has a steel sheet serving as a base material and a galva-annealed layer on the steel sheet. The surface-treating layer contains a base resin and SiO2-coated Al flakes which are Al flakes each having a surface coated with a SiO2 layer. An average thickness of the SiO2 layers is 10 to 100 nm. An average particle size R of the SiO2-coated Al flakes is 1.00 to 30.00 μm. A ratio (R/t) of the average particle size to an average thickness t of the SiO2-coated Al flakes is 10 or more. A coverage by the SiO2-coated Al flakes on a surface of the galva-annealed steel sheet is 20% or more.

### TECHNICAL FIELD

The present invention relates to a surface-treated steel sheet.

### BACKGROUND ART

Zinc-based plated steel sheets are materials widely used in the fields of construction, automobiles, and the like from the viewpoint of improving the corrosion resistance of structural members (see, for example, Patent Document 1 and Patent Document 2 below). Zinc-based plated steel sheets as materials are processed into various shapes and thereafter joined as required by a joining process using fastening members such as screws and bolts, various welding methods, and so on, to form a structural member having a desired shape.

Here, to improve the corrosion resistance of the structural member to be manufactured, various surface-treating films are sometimes formed on the surfaces of the zinc-based plated steel sheets serving as materials. Further, to improve the design of the structural member to be manufactured, various colored films are sometimes formed on the surfaces of the zinc-based plated steel sheets serving as materials. To improve the adhesion of these films during the processing at the time of the manufacture of the structural member, galva-annealed steel sheets (GA) having irregular plated surfaces are sometimes used as materials.

### PRIOR ART DOCUMENT

### Patent Document

Patent Document 1: Japanese Laid-open Patent Publication No. 2016-121390
Patent Document 2: Japanese Laid-open Patent Publication No. 2018-176632

### DISCLOSURE OF THE INVENTION

### Problems to be Solved by the Invention

Here, in the case where a surface-treating film is formed on the surface of a galva-annealed steel sheet to ensure corrosion resistance, since the galva-annealed steel sheet is a plated steel sheet with a low glossy appearance, a desired glossy appearance cannot be obtained when the plated steel sheet with a low glossy appearance is further covered with the surface-treating film. Accordingly, it may not be possible to achieve both corrosion resistance and an improved glossy appearance, and in some applications of the manufactured structural member, it is sometimes difficult to use the galva-annealed steel sheet as a base material.

Under such circumstances, the present invention has been made in consideration of the above-mentioned problem, and it is an object of the present invention to provide a surface-treated steel sheet that uses a galva-annealed steel sheet as a material and can achieve both corrosion resistance and an improved glossy appearance while ensuring the adhesion of its surface-treating film.

### Means for Solving the Problems

To solve the above-mentioned problem, the present inventors conducted intensive studies and as a result, have found out that it may be possible to achieve both corrosion resistance and an improved glossy appearance if the surface-treating layer formed on the galva-annealed steel sheet contains glossy substances. However, it has also been found out that, if the glossy substances are simply contained, the glossy substances aggregate in the surface-treating layer, and it is not possible to obtain the desired effect. Then, the present inventors further conducted studies based on these findings, and as a result, have come up with the present invention described below.

The following is the gist of the present invention completed based on these findings.
(1) A surface-treated steel sheet including: a galva-annealed steel sheet having a steel sheet serving as a base material and a galva-annealed layer on the steel sheet; and a surface-treating layer on the galva-annealed layer, wherein: the surface-treating layer contains a base resin and SiO₂-coated Al flakes which are Al flakes each having a surface coated with a SiO₂ layer; an average thickness of the SiO₂ layers is 10 to 100 nm; an average particle size R of the SiO₂-coated Al flakes is 1.00 to 30.00 μm, and a ratio (R/t) of the average particle size to an average thickness t of the SiO₂-coated Al flakes is 10 or more; and a coverage by the SiO₂-coated Al flakes on a surface of the galva-annealed steel sheet is 20% or more,
the coverage being a value given by the following equation:

$$coverage [ \% ] = ( \sum Ln / {L}_{0} ) \times 100 , \qquad equation ( 1 )$$

where, when a cross section of the surface-treating layer, the galva-annealed layer, and the steel sheet taken along a thickness direction is observed with a scanning electron microscope, L₀ is a dimension of a viewing field in a direction orthogonal to the thickness direction, and Σ Ln is a presence length of the SiO₂-coated Al flakes present in the viewing field.
(2) The surface-treated steel sheet according to (1), wherein the surface-treating layer has an Al content of 0.15 to 12.00 g/m².
(3) The surface-treated steel sheet according to (1) or (2), wherein the galva-annealed layer has a surface roughness of 1.0 to 10.0 μm.
(4) The surface-treated steel sheet according to any one of (1) to (3), wherein the surface-treating layer has an average thickness of 1.0 to 10.0 μm.
(5) The surface-treated steel sheet according to any one of (1) to (4), wherein the average particle size R of the SiO₂-coated Al flakes is 10.00 to 30.00 μm,
(6) The surface-treated steel sheet according to any one of (1) to (5), wherein a ratio (R_{L}/R_{S}) is 1.0 to 5.0, where Rₛ is a minor axis and R_{L} is a major axis of each of the SiO₂-coated Al flakes in plan view of the SiO₂-coated Al flake seen from a thickness-direction upper side of the SiO₂-coated Al flake.
(7) The surface-treated steel sheet according to any one of (1) to (6), wherein the coverage is 50% or more.

### Effect of the Invention

As described above, according to the present invention, in the surface-treated steel sheet using the galva-annealed steel sheet as its material, it is possible to achieve both corrosion resistance and an improved glossy appearance while ensuring the adhesion of the surface-treating film.

### BRIEF DESCRIPTION OF THE DRAWINGS

FIG. 1 is an explanatory view schematically illustrating an example of the configuration of a surface-treated steel sheet according to an embodiment of the present invention.

FIG. 2 is a schematic view to explain SiO₂-coated Al flakes that the surface-treated steel sheet according to this embodiment has.

FIG. 3 is a schematic view to explain the distribution state of the SiO₂-coated Al flakes in a surface-treating layer that the surface-treated steel sheet according to this embodiment has.

FIG. 4 is a schematic view to explain coverage in the surface-treated steel sheet according to this embodiment.

### EMBODIMENTS FOR CARRYING OUT THE INVENTION

Preferred embodiments of the present invention will be hereinafter described in detail with reference to the accompanying drawings. Note that in this specification and the drawings, constituent elements having substantially the same functional configuration will be denoted by the same reference sign and a redundant description thereof will be omitted.

### (Regarding a Surface-Treated Steel Sheet)

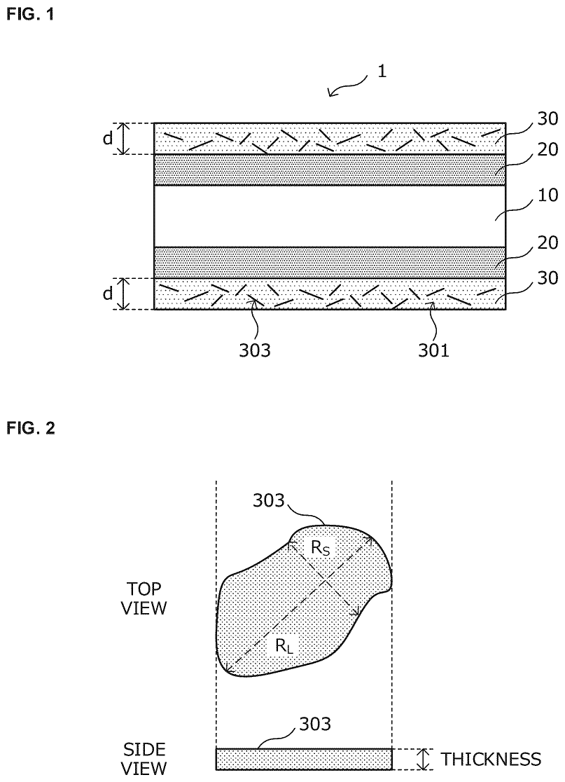

The following will describe the whole structure of a surface-treated steel sheet according to an embodiment of the present invention with reference to FIG. 1. FIG. 1 is an explanatory view schematically illustrating an example of the configuration of the surface-treated steel sheet according to this embodiment.

The surface-treated steel sheet according to this embodiment is especially suitable as a material of a structural member manufactured through joining of a plurality of parts processed into desired shapes.

As schematically illustrated in FIG. 1, the surface-treated steel sheet 1 according to this embodiment has a base steel sheet 10, galva-annealed layers located on both surfaces of the base steel sheet 10, and surface-treating layers 30 located on surfaces of the galva-annealed layers 20.

In the following description, a case where the galva-annealed layer 20 and the surface-treating layer 30 are formed on each of both surfaces of the base steel sheet 10 as illustrated in FIG. 1 will be taken as an example.

### <Regarding the Base Steel Sheet 10>

The dimensions, components, structure, and mechanical properties of the base steel sheet 10 used as a base material of the surface-treated steel sheet 1 according to this embodiment are not limited. For example, depending on the mechanical strength (for example, tensile strength) and so on required of the surface-treated steel sheet 1, various steel sheets are usable as the base steel sheet 10. Examples of such a base steel sheet 10 include iron and steel materials standardized by Japanese Industrial Standards (JIS) and so on and include carbon steel, alloy steel, high-tensile steel, and so on which are used for general structures and mechanical structures. Specific examples of such an iron and steel material include a cold-rolled steel material, a hot-rolled steel material, a hot-rolled steel sheet material for automotive structures, a hot-rolled high-tensile steel sheet material for automotive processing, a cold-rolled steel sheet material for automotive structures, a cold-rolled high-tensile strength steel sheet material for automotive processing, and a high-tensile steel material generally called a hot stamping material quenched at the time of hot working. Components of such an iron and steel material are not limited, but it may contain, in addition to Fe and C, one or two or more of Si, Mn, S, P, Al, N, Cr, Mo, Ni, Cu, Ca, Mg, Ce, Hf, La, Zr, and Sb. To obtain required material strength and formability, one or two or more of these optional additive elements can be appropriately selected, and their contents can also be appropriately adjusted.

Among the above-mentioned high-tensile steels, the use of, for example, high-strength steel with a tensile strength of 780 MPa more (what is called, 780 MPa or higher class high-strength steel) is more preferable because it can improve the robustness of a product. Here, it is possible to measure the tensile strength of the base steel sheet 10 by a known method. For example, a test piece specified in JIS Z 2241:2011 is fabricated from part of a steel sheet whose tensile strength is to be measured, and the tensile strength of the obtained test piece is measured by the prescribed method.

Further, the thickness of the base steel sheet 10 is not limited either and may be appropriately set according to the mechanical strength and so on required of the surface-treated steel sheet 1.

### <Regarding the Galva-Annealed Layers 20>

The galva-annealed layers 20 (hereinafter, sometimes abbreviated simply to “plated layers 20”) according to this embodiment are formed on both surfaces of the above-described base steel sheet 10. Since the surfaces of the galva-annealed layers 20 are irregular as previously mentioned, what is called an anchoring effect ensures that the surface-treating layers 30 formed on the galva-annealed layers 20 adhere to the galva-annealed layers 20.

The galva-annealed layers 20 according to this embodiment preferably have a surface roughness of 1.0 to 10.0 μm in terms of arithmetic mean roughness Ra specified in JIS B 0601:2001. Since the galva-annealed layers have the irregular surfaces with the surface roughness within 1.0 to 10.0 μm, later-described SiO₂-coated Al flakes are held in dents of the surfaces. This makes it possible to achieve the coverage and glossiness, which will be detailed below, while reducing the content of the SiO₂-coated Al flakes. The surface roughness of the galva-annealed layers 20 is more preferably 1.2 μm or more. Further, the surface roughness of the galva-annealed layers 20 is more preferably 5.0 μm or less.

The surface roughness of such galva-annealed layers 20 can be measured as follows, for instance. From the surface-treated steel sheet 1 of interest, a sample with dimensions of 30 mm×30 mm in plan view is cut out. From the sample cut out, the surface-treating layers 30, which will be described later, are peeled off using a coating remover, thereby exposing the galva-annealed layers 20. Then, regarding the sample stripped of the surface-treating layers 30, the measurement is conducted at multiple arbitrary places (for example, three places) using a surface roughness meter conforming to JIS B 0601:2001 (for example, SURFCOM manufactured by TOKYO SEIMITSU CO., LTD). A value equal to a plurality of obtained measurement values averaged by the number of the measurement places may be defined as the surface roughness of the galva-annealed layers 20.

Here, a method to form such galva-annealed layers 20 is not limited, and various known plating bath and alloying methods are usable for the formation.

The coating weight of such galva-annealed layers 20 is not prescribed to a specific value but is preferably about 15 to 120 g/m² per surface of the base steel sheet 10, for instance. With the galva-annealed layers 20 having the coating weight within the above-mentioned range, the surface-treated steel sheet 1 according to this embodiment can exhibit sufficient corrosion resistance.

The coating weight of such galva-annealed layers 20 can be measured as follows, for instance. From the surface-treated steel sheet 1 of interest, a sample with dimensions of 30 mm×30 mm in plan view is cut out. Note that when the sample is cut out, it is cut out all along the thickness direction. From the sample cut out, the surface-treating layers 30, which will be described later, are peeled using a coating remover or the like. Then, the mass of the sample stripped of the surface-treating layers 30 is measured in advance. A tape seal is pasted on one surface of this sample to prevent the galva-annealed layer 20 on this one surface side from melting in the next process. Then, this sample is immersed in a 10% HCl aqueous solution containing an inhibitor, thereby removing the galva-annealed layer 20 by pickling, and the mass of the pickled sample is measured. From a difference between the masses of the sample before and after the pickling, it is possible to determine the coating weight of the galva-annealed layer 20 per surface.

As has been described hitherto, it can be said that the surface-treated steel sheet 1 according to this embodiment uses a galva-annealed steel sheet having the base steel sheet 10 and the galva-annealed layers 20, as the base material when the surface-treating layers 30, which will be described below, are formed.

### <Regarding the Surface-Treating Layers 30>

The surface-treating layers 30 according to this embodiment are formed on the surfaces of the galva-annealed layers 20 described above. Such surface-treating layers 30 each contain a base resin 301 and SiO₂-coated Al flakes 303 as schematically illustrated in FIG. 1.

### [Regarding the Base Resin 301]

The base resin 301 not only functions as a binder resin in the surface-treating layers 30 but also contributes to the corrosion resistance of the surface-treated steel sheet 1 according to this embodiment. In the surface-treating layers 30 according to this embodiment, as the base resin 301, various known organic resins are usable such as a polyester-based resin, a polyurethane-based resin, and an acrylic resin, for instance. Note that these organic resins each may be used alone, or two or more of these may be used in combination. Further, as the base resin 301, various inorganic compounds such as ammonium zirconium carbonate and a silane coupling agent may be contained as additives in addition to the above-mentioned organic resin.

Here, the content of the base resin 301 in the surface-treating layers 30 is preferably 40 mass % or more to the coating solid content, for instance. With the base resin 301 whose content is 40 mass % or more, it is possible to improve the corrosion resistance of the surface-treating layers 30. Further, the content of the base resin 301 in the surface-treating layers 30 is preferably 90 mass % or less and more preferably 70 mass % or less, to the coating solid content, for instance. With the base resin 301 whose content is 90 mass % or less, it is possible to improve the corrosion resistance of the surface-treating layers 30 while ensuring the performance required of the coating films, other than the corrosion resistance.

### [Regarding the SiO₂-Coated Al Flakes 303]

The SiO₂-coated Al flakes 303 (hereinafter, sometimes abbreviated simply to “Al flakes 303”) are glossy substances in which surfaces of flaky substances whose material is Al are coated with SiO₂ layers, and are contained in the surface-treating layers 30 according to this embodiment. The SiO₂-coated Al flakes 303 contained in the surface-treating layers 30 can improve the glossiness of the surface-treated steel sheet 1 according to this embodiment. Further, the SiO₂ layers covering the surfaces of the Al flakes can prevent the Al flakes from aggregating in the surface-treating layers 30, making it possible to appropriately disperse the SiO₂-coated Al flakes 303 in the surface-treating layers 30. Consequently, it is possible to obtain a higher glossy property. As a result, the surface-treated steel sheet 1 according to this embodiment achieves both corrosion resistance and an improved glossy property.

Here, the surface-treating layers 30 according to this embodiment are formed through the applying and drying of a surface treatment agent containing at least the base resin 301 and the SiO₂-coated Al flakes 303. Here, without the SiO₂ layers on the surfaces of the Al flakes, moisture that can present in the surface treatment agent and the Al flakes may react with each other to generate hydrogen, and it may not be possible to effectively use the Al flakes which are contained in the surface treatment agent from the viewpoint of covering the galva-annealed layers 20. Therefore, by covering the surfaces of the Al flakes with the SiO₂ layers, it is possible to inhibit the reaction of the moisture that can present in the surface treatment agent with Al to effectively use the Al flakes. Such inhibition of the reaction of the moisture and Al can be exhibited by the SiO₂ layers having an average thickness of 10 nm or more. From such a viewpoint, the average thickness of the SiO₂ layers is set to 10 nm or more. The average thickness of the SiO₂ layers is preferably 20 nm or more.

On the other hand, by the SiO₂ layers having an average thickness of 100 nm or less, the above-mentioned inhibition of the reaction with the moisture is achieved while the weldability of the surface-treated steel sheet 1 according to this embodiment is ensured. From such a viewpoint, the average thickness of the SiO₂ layers is set to 100 nm or less. The average thickness of the SiO₂ layers is preferably 80 nm or less.

It is possible to determine the average thickness of the SiO₂ layers in the SiO₂-coated Al flakes 303 by observing cross sections of the SiO₂-coated Al flakes 303 with a transmission electron microscope (TEM). In more detail, the SiO₂-coated Al flakes 303 in the surface-treating layers 30 are sampled by FIB processing or the like, and their cross sections are observed with TEM. Five pieces of the SiO₂-coated Al flakes are observed, and the thicknesses of the SiO₂ layers are found. An average of the obtained five numerical values is the average thickness of the SiO₂ layers.

Further, conventionally, in the case where a galva-annealed steel sheet is used to manufacture an electric switchboard, the galva-annealed steel sheet as a material is shaped into a casing with a desired shape, and thereafter the casing is sometimes welded using various welding methods such as laser welding and arc welding. At this time, heat generated at the time of the welding may cause the evaporation of Zn contained in its galva-annealed layers to decrease corrosion resistance. However, it has become clear that by making the above-mentioned SiO₂-coated Al flakes 303 contained in the surface-treating layers 30, it is possible to reduce the evaporation of Zn from the plated layers at the time of the welding.

Al is an element more readily oxidized than Zn. When Al is contained in the surface-treating layers 30 located on more surface layer sides than the galva-annealed layers 20, Al contained in the surface-treating layers is melted by the input heat at the time of the welding quicker than Zn contained in the galva-annealed layers 20. It is considered that as a result, the evaporation of Zn is reduced.

In the surface-treating layers 30 of this embodiment, it is important that Al be flaky. FIG. 2 is an explanatory view to explain the SiO₂-coated Al flake 303 in the surface-treating layers 20 according to this embodiment. In this embodiment, Al contained in the surface-treating layers 30 is flaky Al. Note that in FIG. 2, the SiO₂ layer is not illustrated for convenience' sake. The average particle size R of the SiO₂-coated Al flakes 303 (value when the SiO₂ layers are included) contained in the surface-treating layers 30 is 1.00 to 30.00 μm, and a ratio (R/t) of the average particle size to their average thickness t (value when the SiO₂ layers are included) is 10 or more.

Here, to determine the average particle size R, the surface of the surface-treating layer 30 of interest is observed with a scanning electron microscope (SEM), and when arbitrary Al is selected as Al of interest, the minor axis R_{S} and the major axis R_{L}, illustrated in FIG. 2, of the Al flake 303 of interest are measured using a length measurement function or the like provided in the scanning electron microscope. From the obtained minor axis R_{S} and major axis R_{L}, an average value of these (0.5×(R_{S}+R_{L})) is calculated. Such measurement and calculation are conducted on twenty arbitrary Al flakes. An average value of the obtained twenty values is defined as the average particle size R [unit: μm] of the SiO₂-coated Al flakes 303 in the surface-treating layer 30 of interest.

Further, the average thickness t is determined through the SEM observation of a thickness-direction cross section at an arbitrary position of the surface-treating layer 30 of interest. The thickness of an arbitrary Al flake in the obtained cross section is determined using the length measurement function or the like provided in the scanning electron microscope. The thicknesses of twenty arbitrary Al flakes in the cross section are similarly measured, and an average value of the obtained twenty measurement values is defined as the average thickness t [unit: μm] of the SiO₂-coated Al flakes 303 in the surface-treating layer 30 of interest.

Since Al flakes with an average particle size R of less than 1 μm are not easily available, their use increases the cost required in the manufacture of the surface-treated steel sheet according to this embodiment and is not preferable. In view of this, the average particle size R of the SiO₂-coated Al flakes 303 according to this embodiment is set to 1.00 μm or more. The average particle size R of the SiO₂-coated Al flakes 303 is preferably 5.00 μm or more and is more preferably 10.00 μm or more. With the SiO₂-coated Al flakes 303 having an average particle size R of 1.00 μm or more, it is possible to more efficiently cover the surfaces of the galva-annealed layers 20, leading to the achievement of higher glossiness in the surface-treated steel sheet 1 according to this embodiment. Further, it is possible to more uniformly form Al oxide films on the surfaces of the plated layers when the surface-treated steel sheet 1 according to this embodiment is welded, enabling a further reduction in the evaporation of Zn at the time of the welding.

On the other hand, if the average particle size R of the SiO₂-coated Al flakes 303 is over 30.00 μm, the possibility of the Al flakes protruding from the surface-treating layers 20 becomes high. If the Al flakes protrude from the surface-treating layers 30, their protruding portions gradually corrode, resulting in a color change of the surface-treating layers 30 and a decrease in their corrosion resistance. In view of this, the average particle size R of the SiO₂-coated Al flakes 303 according to this embodiment is set to 30.00 μm or less. If the SiO₂-coated Al flakes 303 have an average particle size R of 30.00 μm or less, it is possible to more efficiently cover the surfaces of the galva-annealed layers 20 while preventing the above-mentioned protrusion of the Al flakes, leading to the achievement of higher glossiness in the surface-treated steel sheet 1 according to this embodiment. Further, when the surface-treated steel sheet 1 according to this embodiment is welded, it is possible to more uniformly form the Al oxide films on the surfaces of the plated layers, enabling a further reduction in the evaporation of Zn at the time of the welding. The average particle size R of the SiO₂-coated Al flakes 303 is preferably 25.00 μm or less.

In achieving the coverage by the Al flakes, which will be described below in detail, by the surface-treating layers 30 according to this embodiment containing the above-described flaky Al, the content of Al contained in the surface-treating layers 30 can be less than in the case where Al that is not flaky is contained. Further, that the content of Al can be reduced also means that the thickness of the surface-treating layers 30 can be reduced. Because of this, it is possible to further reduce the manufacturing cost when the surface-treated steel sheet is manufactured.

Note that the ratio (R_{L}/R_{S}) of the minor axis R_{S} and the major axis R_{L} in the SiO₂-coated Al flakes 303 according to this embodiment is preferably not less than 1.0 nor more than 5.0. That the ratio (R_{L}/R_{S}) of the minor axis R_{S} and the major axis R_{L} is not less than 1.0 nor more than 5.0 means that the shape of the SiO₂-coated Al flakes 303 seen from above is close to a circle. When such SiO₂-coated Al flakes 303 are used, the SiO₂-coated Al flakes 303 where the above-mentioned ratio is achieved appropriately enter the dents present in the surfaces of the galva-annealed layers 20. Consequently, it is possible to more efficiently cover the surfaces of the galva-annealed layers 20 while preventing the SiO₂-coated Al flakes 303 from protruding from the surface-treating layers 30. As a result, a value of the coverage by the Al flakes, which will be described in detail below, can be higher, achieving a higher glossiness. Further, the ratio (R_{L}/R_{S}) of the minor axis R_{S} and the major axis R_{L} is more preferably 2.0 or less. The ratio (R_{L}/R_{S}) of the minor axis R_{S} and the major axis R_{L} can be calculated using the values of the minor axis R_{S} and the major axis R_{L} which are obtained when the average particle size R is measured by the above-mentioned method.

Further, in the SiO₂-coated Al flakes 303 according to this embodiment, the ratio (R/t) of the average particle size to the average thickness t is more preferably 50 or more. With the ratio (R/t) of the average particle size to the average thickness t being 50 or more, it is possible to obtain a larger coverage with a smaller amount of the Al flakes, effectively achieving improved glossiness and post-welding corrosion resistance.

On the other hand, in the SiO₂-coated Al flakes 303 according to this embodiment, the larger the ratio (R/t) of the average particle size to the average thickness t, the better, and its upper limit value is not particularly prescribed. However, in practice, the upper limit of the ratio (R/t) of the average particle size to the average thickness t is about 300.

In the surface-treating layers 30 according to this embodiment, the content of the SiO₂-coated Al flakes 303 is preferably 0.15 to 12.00 g/m² in terms of metallic Al. The SiO₂-coated Al flakes 303 with a content of 0.15 g/m² or more can surely exhibit the above-mentioned glossiness-improving effect and effect of reducing the Zn evaporation at the time of the welding. The content of the SiO₂-coated Al flakes 303 is more preferably 1.00 g/m² or more, still more preferably 2.40 g/m² or more, and yet more preferably 5.00 g/m² or more. On the other hand, as previously described, since the SiO₂-coated Al flakes 303 having the above-mentioned specific shape are contained in the surface-treating layers 30 according to this embodiment, it is possible to reduce the content of the SiO₂-coated Al flakes 303 to 12.00 g/m² or less. The content of the SiO₂-coated Al flakes 303 is more preferably 10.00 g/m² or less, and still more preferably 8.00 g/m² or less.

Here, in the case where the content of the SiO₂-coated Al flakes 303 in the surface-treating layers 30 is determined from the manufactured surface-treated steel sheet 1, it can be determined as follows.

First, from the surface-treated steel sheet of interest, a sample is cut out, the measurement is conducted on the surface-treating layers in the obtained sample every 0.01 μm from their surfaces toward the plated layers using a glow discharge optical emission spectrometer (GD-OES), and an average value of the Al concentrations is found. Here, in a plurality of comparative samples having surface-treating layers whose Al flake contents are known, area ratios of regions where Al is present are found by the same method as above, and a calibration curve is prepared in advance based on the relation with the content of the pigment. It is possible to find the content of the Al flakes in the target sample using the obtained calibration curve.

Note that in the surface-treating layers 30 according to this embodiment, the SiO₂-coated Al flakes 303 may have a void shape (for example, a doughnut shape) as long as they have the above-mentioned outer shape.

In addition to the SiO₂-coated Al flakes 303 or in place of the SiO₂-coated Al flakes 303, those in which surfaces of Al alloy flakes whose materials are various Al alloys are covered with SiO₂ (hereinafter, also referred to as “SiO₂-coated Al alloy flakes”) are also usable in the surface-treating layers 30 according to this embodiment.

The average thickness of the SiO₂ layers and the shape of the flakes in such SiO₂-coated Al alloy flakes, and the content of the SiO₂-coated Al alloy flakes are the same as in the SiO₂-coated Al flakes 303, and therefore, a detailed description thereof will be omitted below.

Examples of the above-mentioned SiO₂-coated Al alloy flakes include SiO₂-coated Al—Fe alloy flakes, SiO₂-coated Al—Fe—Si alloy flakes, SiO₂-coated Al—Mn alloy flakes, SiO₂-coated Al—Mn—Si alloy flakes, SiO₂-coated Al—Si alloy flakes, SiO₂-coated Al—Si—Mg alloy flakes, SiO₂-coated Al—Si—Cu alloy flakes, and SiO₂-coated Al—Mg—Cu alloy flakes.

### [Regarding Other Components]

The surface-treating layers 30 according to this embodiment each may further contain a rust-inhibitive pigment, an extender pigment, a color pigment, a rust inhibitor, a dispersion stabilizer, and so on in addition to the above-mentioned components within a range not impairing the effects described above. Further, the surface-treating layers 30 according to this embodiment each may contain various chemical treatment components such as a chromate-based chemical treatment component and a non-chromate chemical treatment component, in addition to the above-mentioned components.

### [Regarding the Distribution State of the SiO₂-Coated Al Flakes]

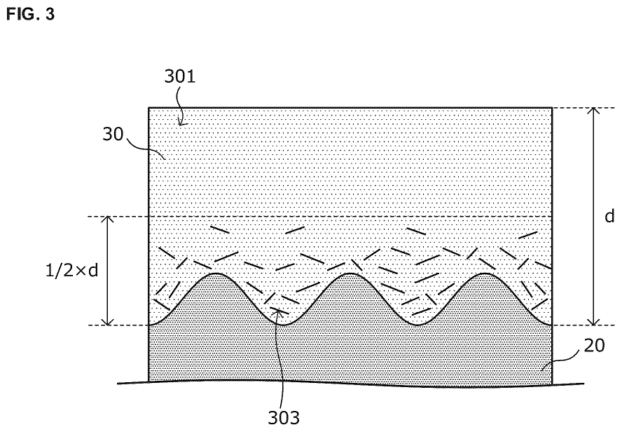

Subsequently, the distribution state of the SiO₂-coated Al flakes 303 in the surface-treating layers 30 according to this embodiment will be described with reference to FIG. 3. FIG. 3 is a schematic view to explain the distribution state of the SiO₂-coated Al flakes in the surface-treating layer that the surface-treated steel sheet of this embodiment has.

In the surface-treating layers 30 according to this embodiment, the above-described SiO₂-coated Al flakes 303 are used, and after a manufacturing method, which will be detailed below, is executed, the SiO₂-coated Al flakes 303 do not uniformly disperse in the thickness direction of the surface-treating layers 30 but are unevenly distributed, concentrating in regions near interfaces between the galva-annealed layers 20 and the surface-treating layers 30.

The following will describe the concentrated distribution state of the SiO₂-coated Al flakes 303, with a focus on the relation with the average thickness (thickness d in FIG. 3) of the surface-treating layer 30.

Here, as schematically illustrated in FIG. 3, the surface of the galva-annealed layer 20 has irregularities. The average thickness d of the surface-treating layer 30 is an average thickness from an average position of valley parts of the irregularities in the interface, where such irregularities are present, between the galva-annealed layer 20 and the surface-treating layer 30 up to the surface of the surface-treating layer 30.

As schematically illustrated in FIG. 3, in the surface-treating layer 30 of this embodiment, the SiO₂-coated Al flakes 303 concentrate in a range from the interface between the galva-annealed layer 20 and the surface-treating layer 30 up to a position apart from the interface toward the surface of the surface-treating layer 30 by the average thickness d×(½). As illustrated in FIG. 3, owing to the concentrated distribution of the SiO₂-coated Al flakes 303 in the region closer to the interface with the galva-annealed layer 20, it is possible to inhibit light reflected on the interface with the galva-annealed layer 20 from irregularly reflecting due to the SiO₂-coated Al flakes 303. Consequently, in the surface-treated steel sheet 1 according to this embodiment, it is possible to improve glossiness while reducing the content of the SiO₂-coated Al flakes 303 to a small value.

Further, the above-mentioned concentrated distribution of the Al flakes makes it possible to more quickly melt Al at the time of the welding to more uniformly form the Al oxide film on the surface of the plated layer, making it possible to further reduce the evaporation of Zn at the time of the welding.

In more detail, in the surface-treating layer 30 according to this embodiment, the SiO₂-coated Al flakes 303 preferably concentrate near the interface with the galva-annealed layer 20 such that the amount of Al present in the range up to the position of the average thickness d×(½) is 70% or more.

Here, it is possible to determine whether or not the SiO₂-coated Al flakes 303 are concentrating near the interface with the galva-annealed layer by observing a cross section of the surface-treating layer 30, the galva-annealed layer 20, and the base steel sheet 10 taken along the thickness direction, using a scanning electron microscope (SEM) equipped with an electron probe micro analyzer (EPMA). Here, to obtain the cross section to be observed, the surface of a sample of the surface-treated steel sheet 1 of interest is covered with metal such as gold, then the sample is cut in the thickness direction, and the obtained cross section is polished by a known method.

Then, a back scattered electron (BSE) image of the cross section of interest and an elemental mapping image regarding an Al element and a Si element are obtained, and the distribution state of the Al flakes present in the range up to the position of the average thickness d×(½) is determined.

At this time, a value calculated by the following equation is the ratio of the amount of Al present in the range up to the position of the average thickness d× (½).
the ratio of the amount of Al present in the range up to the position of the average thickness d×(½)
=100×(the area of the Al flakes present in the range up to the position of the average thickness d×(½))/(the area of the Al flakes present in the surface-treating layer)

The above-described measurement and calculation are conducted on five arbitrary cross sections, and an average value of the obtained ratios in the five viewing fields is handled as the ratio of the amount of Al present in the range up to the position of the average thickness d×(½) in the surface-treated steel sheet 1 of interest.

### [Regarding the Coverage by the SiO₂-Coated Al Flakes]

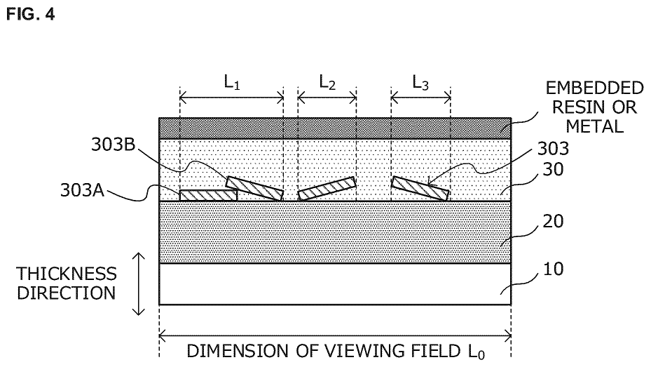

In the surface-treated steel sheet 1 according to this embodiment, the coverage R_{C} by the above-described SiO₂-coated Al flakes 303 on the surfaces of the plated steel sheets (more specifically, the surfaces of the galva-annealed layers 20) is 20% or more. The following will describe the coverage R_{C} by the SiO₂-coated Al flakes 303 with reference to FIG. 4. FIG. 4 is a schematic view to explain the coverage in the surface-treated steel sheet 1 according to this embodiment. Note that the irregularities present on the surface of the galva-annealed layer 20 are omitted in FIG. 4.

Here, when the coverage by the SiO₂-coated Al flakes 303 is to be considered, a cross section of the surface-treating layer 30, the galva-annealed layer 20, and the base steel sheet 10 taken along the thickness direction as schematically illustrated in FIG. 4 is observed with a scanning electron microscope (SEM). Here, to obtain the cross section to be observed, the surface of a sample of the surface-treated steel sheet 1 of interest is covered with metal such as gold, then the sample is cut in the thickness direction, and the obtained cross section is polished by a known method as in the above.

The obtained cross section is observed at a 1000× observation magnification using SEM. Here, the dimension of a viewing field in a direction orthogonal to the thickness direction is represented by L₀ as illustrated in FIG. 4. Note that the dimension L₀ of the viewing field may be, for example, 40 μm. Further, the width of each of the SiO₂-coated Al flakes 303 present in the surface-treating layer 30 when it is projected vertically to the surface extending in the direction orthogonal to the thickness direction is represented by Lᵢ. Here, the subscript i is a parameter indicating the number of the SiO₂-coated Al flakes 303 in the field of view and is an integer of 1 or more. The width Lᵢ of each of the SiO₂-coated Al flakes 303 present in the field of view when they are projected is measured, and the sum of the obtained measurement values is represented by Σ Ln (n corresponds to the number of the SiO₂-coated Al flakes 303 present in the field of view).

In the example illustrated in FIG. 4, four SiO₂-coated Al flakes 303 are present in the surface-treating layer 30 in the field of view. At this time, in the case where the SiO₂-coated Al flakes overlap when seen in the projection direction as the SiO₂-coated Al flakes 303A, 303B in FIG. 4 do, the lengths of the individual projected SiO₂-coated Al flakes 303 are not added (the lengths of the overlapping portions are not repeatedly included in the addition), but all of the overlapping SiO₂-coated Al flakes 303 are handled as one lump. In the case of the example illustrated in FIG. 4, the SiO₂-coated Al flakes 303A, 303B are handled as one lump, and Σ Ln is a value represented by L₁+L₂+L₃.

Then, using the L₀ and Σ Ln obtained in the above-described manner, the coverage R_{C} (unit: %) is calculated based on the following equation (101).

$$coverage {R}_{C} [ \% ] = ( \sum Ln / {L}_{0} ) \times 100 \qquad equation ( 101 )$$

The above-described measurement and calculation are conducted regarding five arbitrary viewing fields, and an average value of the coverages R_{C} obtained in the five viewing fields is handled as the coverage R in the surface-treated steel sheet 1 of interest.

If the above-described coverage R_{C} is less than 20%, the galva-annealed layer 20 has too many parts not covered with the SiO₂-coated Al flakes 303, and it is not possible to obtain the glossiness-improving effect and the effect of reducing the Zn evaporation at the time of the welding. With the coverage R_{C} of 20% or more, it is possible to obtain the glossiness-improving effect and the effect of reducing the Zn evaporation at the time of the welding. The coverage R_{C} by the SiO₂-coated Al flakes 303 is preferably 50% or more, and more preferably 70% or more. The higher the coverage R_{C} by the SiO₂-coated Al flakes 303, the better, and the coverage R_{C} may be 100%.

Note that it is possible to control such coverage R to a desired value by controlling the surface roughness of the galva-annealed layers 20, the shape (the average thickness of the SiO₂ layers, the average particle size R, the average thickness t, and so on) of the SiO₂-coated Al flakes 303 contained in the surface-treating layers 30, their content, the average thickness d, which will be described later, of the surface-treating layers 30, and so on.

### [Regarding the Average Thickness]

The average thickness (thickness d in FIG. 1 and FIG. 3) of the surface-treating layers 30 according to this embodiment is preferably 1.0 to 10.0 μm, for instance. The surface-treating layers 30 with an average thickness of 1.0 μm or more can surely exhibit the corrosion- and glossiness-improving effects and the effect of reducing the Zn evaporation at the time of the welding. The average thickness of the surface-treating layers is more preferably 2.0 μm or more, and still more preferably 4.0 μm or more. On the other hand, the surface-treating layers 30 having an average thickness of 10.0 μm or less can surely exhibit the corrosion- and glossiness-improving effects and the effect of reducing the Zn evaporation at the time of the welding while reducing an increase in the manufacturing cost of the surface-treated steel sheet 1. The average thickness of the surface-treating layers 30 is more preferably 9.0 μm or less, and still more preferably 7.0 μm or less.

The above-described average thickness of the surface-treating layers can be determined as follows. Thickness-direction cross sections at five arbitrary places of the surface-treated steel sheet 1 of interest are observed, the thickness of the surface-treating layers 30 at each of the places is measured, and then the obtained five measurement values are averaged.

Hitherto, the surface-treated steel sheet 1 according to this embodiment has been described in detail with reference to FIG. 1 to FIG. 4.

In the above description, the case where the galva-annealed layer 20 and the surface-treating layer 30 are provided on each of both surfaces of the base steel sheet 10 is taken as an example. However, it is only necessary that the galva-annealed layer 20 and the surface-treating layer 30 be provided on at least one surface of the base steel sheet 10. However, considering the corrosion resistance of the whole structural member to be manufactured, it is preferable to provide the galva-annealed layers 20 and the surface-treating layers 30 on both surfaces of the base steel sheet 10 as illustrated in FIG. 1.

Further, the surface-treated steel sheet 1 according to this embodiment may further have a chemical treatment coating layer (not illustrated) containing various known chemical treatment components, in addition to the above-described galva-annealed layers 20 and surface-treating layers 30.

### (Regarding the Method of Manufacturing the Surface-Treated Steel Sheet)

Subsequently, an example of the method of manufacturing the surface-treated steel sheet according to this embodiment will be described.

The surface-treated steel sheet according to this embodiment is manufactured as follows. First, the above-described base steel sheet 10 is used as a base material, and the galva-annealed layers 20 are formed on the surfaces of the base steel sheet 10, and thereafter the surface-treating layers are formed on the surfaces of the galva-annealed layers 20.

To form the galva-annealed layers 20, a hot-dip plating method can be employed.

In a manufacturing process of such a plated steel sheet, the steel sheet used as the base material is first rolled to a desired sheet thickness by a Sendzimir method, thereafter wound into a coil, and installed on a hot-dip plating line.

On the hot-dip plating line, the base steel sheet is continuously passed while being let out from the coil. At this time, the base steel sheet is subjected to, for example, 800° C. thermal reduction treatment in an N₂-5% H₂ gas atmosphere under an environment of 20 ppm oxygen concentration or less by annealing facilities provided on the line, thereafter air-cooled with N₂ gas to around a subsequent-stage plating bath temperature+20° C., and immersed in the plating bath.

Here, in the plating bath, a molten plating metal having chemical components for forming a desired plated layer is prepared in advance. The bath temperature of the plating bath is set to the melting point of the plating metal or higher (for example, about 460 to 660° C.). When the materials of the plating metal are prepared, a pure metal (with a 99% purity or more) is used as the metal material at the time of compounding. First, a predetermined amount of the metal material is mixed such that the composition of the above-described plated layer can be obtained, and it is completely melted under a vacuum or inert gas replacement condition, using a high-frequency induction furnace, an arc furnace, or the like. Further, the plating metal containing the mixed predetermined components is melted in the atmosphere, and the obtained melt is used as the plating bath.

In the preparation of the plating metal described above, there is no special restriction that the pure metal must be used, and an existing Zn alloy, Mg alloy, or Al alloy may be melted to be used. At this time, there is no problem as long as an alloy with little impurity and with a predetermined composition is used.

After the base steel sheet is immersed in the plating bath described above, it is pulled up at a predetermined rate. At this time, the plating weight is controlled using, for example, an N₂ wiping gas so that the formed plated layer will have a desired thickness. Here, as for the condition other than the bath temperature, a typical plating operation condition may be employed, and no special facilities or conditions are required.

After the base steel sheet is pulled up from the plating bath, there follows an alloying heat-treatment process (for example, a heat treatment process involving heating to about an ultimate sheet temperature of 480 to 550° C.), which is often executed in the typical manufacture of a galva-annealed steel sheet. Consequently, it is possible to manufacture the galva-annealed steel sheet.

The surface-treating layers 30 are formed on the surfaces of the galva-annealed steel sheet manufactured in, for example, the above-described manner. At this time, the surface treatment agent is prepared in which the base resin, the SiO₂-coated Al flakes, and so on with desired contents are contained in any of various solvents (for example, an aqueous solvent such as pure water). Besides, treatment agents or the like for forming the other layers (for example, the chemical treatment coating layer and so on) are also prepared as required, using various known methods.

By applying the prepared surface treatment agent and various other treatment agents to form desired layer structures and thereafter drying and baking them, it is possible to manufacture the surface-treated steel sheet.

Here, the various treatment agents can be applied by a generally known coating method, for example, roll coating, curtain flow coating, air spraying, airless spraying, immersing, bar coating, brushing, or the like.

Further, at the time of the drying and baking, by controlling the baking temperature (the ultimate temperature of the metal surface), the heating residue (what is called a NV (Nonvolatile content) value) of the surface treatment agent, a time period from the application of the surface treatment agent up to the baking, and so on, it is possible to control the distribution state of and the coverage by the Al flakes.

For example, controlling the baking temperature within a range of 100 to 150° C. makes it possible to attain more preferable states of the surface glossiness and the distribution state of and the coverage by the Al flakes. Further, controlling the nonvolatile content value within a range of 5 to 25% makes it possible to attain more preferable states of the surface glossiness and the distribution state of and the coverage by the Al flakes. Further, controlling the time period from the application of the surface treatment agent up to the baking to five seconds or more makes it possible to attain more preferable states of the surface glossiness and the distribution state of and the coverage by the Al flakes.

Hitherto, an example of the method of manufacturing the surface-treated steel sheet according to this embodiment has been described.

### EXAMPLES

The surface-treated steel sheet according to the present invention will be hereinafter specifically described while presenting Examples and Comparative Examples. It should be noted that Examples below are only examples of the surface-treated steel sheet according to the present invention, and the surface-treated steel sheet according to the present invention is not limited to Examples below.

### (Preparation of Base Steel Sheets and Plating Layers)

In the following verification examples, prepared were plated steel sheets (all are manufactured by NIPPON STEEL CORPORATION) in which four types of plated layers described below were formed on 980 MPa-class high-strength steel sheets with a 1.6 mm sheet thickness.

GA: a galva-annealed steel sheet in which a galva-annealed layer is formed with a coating weight of 45 g/m² per surface

GI: a hot-dip galvanized steel sheet in which a hot-dip galvanized layer is formed with a coating weight of 45 g/m² per surface

SD: a Zn-based alloy plated steel sheet in which a Zn-11 mass % Al-3 mass % Mg-0.2 mass % Si alloy plated layer is formed with a coating weight of 45 g/m² per surface

ZM: a Zn-based alloy plated steel sheet in which a Zn-6 mass % Al-3 mass % Mg alloy plating layer is formed with a coating weight of 45 g/m² per surface

The surface roughness (Ra) of each of the prepared plated steel sheets was measured by the previously described method, using a surface roughness meter (SURFCOM manufactured by TOKYO SEIMITSU CO., LTD.), and Table 1 shows the obtained results.

### (Preparation of Surface Treatment Agents for Forming Surface-Treating Layers)

As base resins, a polyurethane resin, a polyester resin, and an acrylic resin (all are commercially available) were prepared. Further, as SiO₂-coated Al flakes, EMERAL (registered trademark) series manufactured by Toyo Aluminium K. K. was used. Note that the thicknesses of SiO₂ layers of the used SiO₂-coated Al flakes are as shown in Table 1 below. Further, for comparison, ordinary Al flakes not coated with SiO₂ layers were also additionally prepared.

The prepared base resins and Al flakes with the contents shown in Table 1 below were added to pure water as a solvent, to prepare the surface treatment agents. The obtained surface treatment agents were applied using a bar coater such that the average thicknesses of surface-treating layers after drying would become the values shown in Table 1 below, baked under the conditions shown in Table 1 using an air heating furnace, and thereafter air-cooled to room temperature. In the above-described manner, a plurality of samples of the surface-treated steel sheet were fabricated regarding the respective standards. Note that in Table 1 below, nonvolatile content (NV value) (%), metal surface ultimate temperature (° C.), and time period from the application up to the baking (second) are shown as the condition at the time of the baking.

After Au was vapor-deposited on the surfaces of the obtained surface-treated steel sheets, their surfaces and cross sections were observed with SEM by the previously described methods, thereby measuring a major axis/minor axis (R_{L}/R_{S}) ratio of the Al flakes, their average particle size R, their average thickness t, and coverage R_{C} by the Al flakes in each of the surface-treating layers and observing the distribution states of the Al flakes. Table 1 below summarizes the obtained results.

The distribution state of the Al flakes was scored as follows based on values of the ratios calculated in the above-described manner.
score A: The calculated ratio is 90% or more.
score B: The calculated ratio is 70% or more and less than 90%.
score C: The calculated ratio is less than 70%.

TABLE 1

| | | | SURFACE-TREATING LAYER | | | | | | | | | |
|---|---|---|---|---|---|---|---|---|---|---|---|---|
| | | | | | Al FLAKES | | | | | | | |
| | PLATED STEEL | | | | | | | | | | AVERAGE | |
| | | SURFACE | | | | | | | | WITH/ | THICK- | |
| | | ROUGH- | RESIN COMPONENT | | | | | | Al | WITH- | NESS | |
| | | NESS | | CON- | | | | | CON- | OUT SiO₂ | OF SiO₂ | DISTRIBU- |
| | | Ra | | TENT | | R | t | | TENT | LAYER | LAYER | TION |
| No. | TYPE | (μm) | TYPE | (%) | R_{L}/R_{S} | (μm) | (μm) | R/t | (g/m²) | COATING | (nm) | STATE |
| 1 | GA | 1.2 | POLYURETHANE | 90 | 1.2 | 19.00 | 0.20 | 95 | 0.20 | WITH | 30 | B |
| 2 | GA | 1.2 | POLYURETHANE | 90 | 1.2 | 19.00 | 0.20 | 95 | 0.40 | WITH | 30 | B |
| 3 | GA | 1.2 | POLYURETHANE | 70 | 1.2 | 19.00 | 0.20 | 95 | 1.20 | WITH | 30 | B |
| 4 | GA | 1.2 | POLYURETHANE | 70 | 1.2 | 19.00 | 0.20 | 95 | 2.40 | WITH | 30 | B |
| 5 | GA | 1.2 | POLYURETHANE | 50 | 1.2 | 19.00 | 0.20 | 95 | 4.00 | WITH | 30 | B |
| 6 | GA | 1.2 | POLYURETHANE | 70 | 1.2 | 19.00 | 0.20 | 95 | 7.10 | WITH | 30 | B |
| 7 | GA | 1.2 | POLYURETHANE | 70 | 1.3 | 8.00 | 0.20 | 40 | 7.10 | WITH | 15 | B |
| 8 | GA | 1.2 | POLYESTER | 70 | 1.2 | 19.00 | 0.20 | 95 | 2.40 | WITH | 30 | B |
| 9 | GA | 1.2 | POLYESTER | 70 | 1.2 | 19.00 | 0.20 | 95 | 7.20 | WITH | 30 | B |
| 10 | GA | 1.2 | ACRYLIC | 70 | 1.2 | 19.00 | 0.20 | 95 | 2.40 | WITH | 30 | B |
| 11 | GA | 1.2 | ACRYLIC | 70 | 1.2 | 19.00 | 0.20 | 95 | 7.30 | WITH | 30 | B |
| 12 | GA | 1.2 | POLYURETHANE | 70 | 1.2 | 19.00 | 0.20 | 95 | 2.40 | WITH | 30 | B |
| 13 | GA | 1.2 | POLYURETHANE | 70 | 1.2 | 19.00 | 0.20 | 95 | 7.10 | WITH | 30 | B |
| 14 | GA | 1.2 | POLYURETHANE | 95 | 1.2 | 19.00 | 0.20 | 95 | 0.10 | WITH | 30 | B |
| 15 | GA | 1.2 | POLYURETHANE | 80 | 1.2 | 19.00 | 0.20 | 95 | 0.20 | WITH | 30 | B |
| 16 | GA | 1.2 | POLYURETHANE | 90 | 1.1 | 0.80 | 0.05 | 16 | 0.20 | WITH | 15 | B |
| 17 | GA | 1.2 | POLYURETHANE | 90 | 1.3 | 35.00 | 0.20 | 175 | 0.20 | WITH | 30 | B |
| 18 | GA | 1.2 | POLYURETHANE | 90 | 1.1 | 6.00 | 1.00 | 6 | 0.30 | WITH | 30 | B |
| 19 | GA | 1.2 | POLYURETHANE | 90 | 1.2 | 19.00 | 0.20 | 95 | 0.40 | WITH | 120 | B |
| 20 | GA | 1.2 | POLYURETHANE | 90 | 7.5 | 15.00 | 0.20 | 75 | 0.20 | WITH | 30 | B |
| 21 | GA | 1.2 | POLYURETHANE | 100 | — | — | — | — | — | — | — | B |
| 22 | GA | 1.2 | — | — | — | — | — | — | — | — | — | B |
| 23 | GI | 0.4 | POLYURETHANE | 90 | 1.2 | 19.00 | 0.20 | 95 | 0.40 | WITH | 30 | B |
| 24 | SD | 0.8 | POLYURETHANE | 90 | 1.2 | 19.00 | 0.20 | 95 | 0.40 | WITH | 30 | B |
| 25 | ZM | 0.7 | POLYURETHANE | 90 | 1.2 | 19.00 | 0.20 | 95 | 0.40 | WITH | 30 | B |
| 26 | GA | 1.2 | POLYURETHANE | 90 | 1.2 | 19.00 | 0.20 | 95 | 0.20 | WITHOUT | — | B |
| 27 | GA | 1.2 | POLYURETHANE | 90 | 1.2 | 19.00 | 0.20 | 95 | 0.20 | WITH | 7 | B |
| 28 | GA | 1.2 | POLYURETHANE | 70 | 1.4 | 28.00 | 0.2 | 140 | 1.70 | WITH | 80 | B |
| 29 | GA | 9.6 | POLYURETHANE | 90 | 1.3 | 8.00 | 0.20 | 40 | 0.40 | WITH | 15 | B |
| 30 | GA | 1.2 | POLYURETHANE | 55 | 1.2 | 19.00 | 0.20 | 95 | 5.50 | WITH | 30 | A |
| 31 | GA | 1.2 | POLYURETHANE | 90 | 1.2 | 19.00 | 0.20 | 95 | 0.40 | WITH | 30 | C |
| 32 | GA | 1.2 | POLYURETHANE | 70 | 1.2 | 19.00 | 0.20 | 95 | 1.20 | WITH | 30 | B |
| 33 | GA | 1.2 | POLYURETHANE | 90 | 1.2 | 19.00 | 0.20 | 95 | 0.40 | WITH | 30 | C |

| | SURFACE-TREATING LAYER | | | | | |
|---|---|---|---|---|---|---|
| | AVERAGE | | | | | |
| | THICKNESS | COVER- | MANUFACTURING CONDITION | | | |
| | OF SURFACE | AGE BY | NON | BAKING | | |
| | TREATING | Al | VOLATILE | TEMPER- | TIME | |
| | LAYER | FLAKES | CONTENT | ATURE | PERIOD | CLASSIFI- |
| No. | (μm) | (%) | (%) | (° C.) | (sec) | CATION |
| 1 | 1.0 | 23 | 24 | 140 | 6 | EXAMPLE |
| 2 | 2.0 | 37 | 24 | 140 | 6 | EXAMPLE |
| 3 | 2.0 | 50 | 24 | 140 | 6 | EXAMPLE |
| 4 | 4.0 | 70 | 24 | 140 | 6 | EXAMPLE |
| 5 | 4.0 | 75 | 24 | 140 | 6 | EXAMPLE |
| 6 | 7.0 | 98 | 24 | 140 | 6 | EXAMPLE |
| 7 | 7.0 | 85 | 24 | 140 | 6 | EXAMPLE |
| 8 | 4.0 | 72 | 24 | 140 | 6 | EXAMPLE |
| 9 | 7.0 | 95 | 24 | 140 | 6 | EXAMPLE |
| 10 | 4.0 | 70 | 24 | 140 | 6 | EXAMPLE |
| 11 | 7.0 | 93 | 24 | 140 | 6 | EXAMPLE |
| 12 | 4.0 | 70 | 24 | 140 | 6 | EXAMPLE |
| 13 | 7.0 | 98 | 24 | 140 | 6 | EXAMPLE |
| 14 | 1.0 | 12 | 24 | 140 | 6 | COMPARATIVE |
| | | | | | | EXAMPLE |
| 15 | 0.5 | 22 | 24 | 140 | 6 | EXAMPLE |
| 16 | 1.0 | 21 | 24 | 140 | 6 | COMPARATIVE |
| | | | | | | EXAMPLE |
| 17 | 1.0 | 25 | 24 | 140 | 6 | COMPARATIVE |
| | | | | | | EXAMPLE |
| 18 | 2.0 | 25 | 24 | 140 | 6 | COMPARATIVE |
| | | | | | | EXAMPLE |
| 19 | 2.0 | 33 | 24 | 140 | 6 | COMPARATIVE |
| | | | | | | EXAMPLE |
| 20 | 1.0 | 22 | 24 | 140 | 6 | EXAMPLE |
| 21 | 2.0 | 0 | 24 | 140 | 6 | COMPARATIVE |
| | | | | | | EXAMPLE |
| 22 | — | 0 | 24 | 140 | 6 | COMPARATIVE |
| | | | | | | EXAMPLE |
| 23 | 2.0 | 26 | 24 | 140 | 6 | COMPARATIVE |
| | | | | | | EXAMPLE |
| 24 | 2.0 | 30 | 24 | 140 | 6 | COMPARATIVE |
| | | | | | | EXAMPLE |
| 25 | 2.0 | 28 | 24 | 140 | 6 | COMPARATIVE |
| | | | | | | EXAMPLE |
| 26 | 1.0 | 13 | 24 | 140 | 6 | COMPARATIVE |
| | | | | | | EXAMPLE |
| 27 | 1.0 | 15 | 24 | 140 | 6 | COMPARATIVE |
| | | | | | | EXAMPLE |
| 28 | 3.0 | 60 | 24 | 140 | 6 | EXAMPLE |
| 29 | 10.0 | 35 | 24 | 140 | 6 | EXAMPLE |
| 30 | 6.0 | 85 | 8 | 140 | 6 | EXAMPLE |
| 31 | 2.0 | 15 | 30 | 140 | 6 | COMPARATIVE |
| | | | | | | EXAMPLE |
| 32 | 2.0 | 52 | 24 | 170 | 6 | EXAMPLE |
| 33 | 2.0 | 18 | 24 | 140 | 3 | COMPARATIVE |
| | | | | | | EXAMPLE |

### (Evaluation)

The obtained samples of the surface-treated steel sheet were laser-welded or arc-welded, with the two same ones used as an upper plate and a lower plate, thereby fabricating welded joints. Then, in each of the obtained welded joints, the glossiness and color tone of a flat portion were measured, and regarding the welded joints having undergone the glossiness and color tone measurement, the corrosion resistance and the adhesion of the flat portion and the welded portion were evaluated in accordance with the following evaluation methods. Details are as follows. Further, Table 2 below summarizes the obtained results.

### <Execution of the Laser Welding/Arc Welding>

The obtained samples of the surface-treated steel sheet were subjected to lap fillet welding by laser welding or arc welding, with the two same ones used as the upper plate and the lower plate, thereby fabricating the welded joints. Here, the upper plate had dimensions of 50 mm×150 mm, the lower plate had dimensions of 30 mm×150 mm, the overlap width of the upper plate and the lower plate was 10 mm, and a plate gap was 0 mm.

Here, the welding condition in the laser welding is as follows.
power: 3 kW
welding speed: 300 cm/minute
push/drag angle: 0°

Further, the welding condition and a used welding wire in the arc welding are as follows.
welding wire: wire for mild steel (YM-24T manufactured by NIPPON STEEL WELDING & ENGINEERING CO., LTD., ¢ 1.2 mm)
(C: 0.07 mass %, Si: 0.51 mass %, Mn: 1.2 mass %, P: 0.013 mass %, S: 0.004 mass %, Cu: 0.31 mass %)
   shielding gas: Ar+20% CO₂
   welding torch tilt angle: 60°
welding current: 140 A
   welding voltage: 11.4 V
   welding speed: 80 cm/min

### <Glossiness>

Glossiness was measured by a method conforming to JIS Z8741 (1977). 60° specular gloss Gs) (60° was measured using a commercially available digital variable-angle gloss meter (manufactured by Suga Test Instruments Co., Ltd., model: UGV-6P). At this time, the optical axis direction of the gloss meter was set to the L direction of the obtained samples. Note that the measurement was also separately conducted with the optical axis direction of the gloss meter being set to the C direction, but there was no significant difference from the case where the optical axis direction was set to the L direction.

Evaluation was conducted based on the following evaluation criteria, and score A and higher were considered passing.

### [Evaluation Criteria]

score AAA: The 60° specular gloss is over 50.
   AA: The 60° specular gloss is over 30 and 50 or less
      A: The 60° specular gloss is over 20 and 30 or less.
      B: The 60° specular gloss is 20 or less.

### <Color Tone>

The measurement was conducted by a method conforming to CIE 1976 of JIS K5600-4-4 (1999). An L* value was measured using a commercially available colorimeter (CR-400 Hand manufactured by Konica Minolta, Inc.). Note that an a* value and a b* value were within a −1.0 to +1.0 range in all the samples.

The evaluation was conducted based on the following evaluation criteria, and score A and higher were considered passing.

### [Evaluation Criteria]

score AA: The L* value is over 80.
   A: The L* value is over 65 and 80 or less.
   B: The L* value is 65 or less.

### <Corrosion Evaluation>

The obtained welded joints were subjected to a combined cyclic corrosion test conforming to JASO M609-91, with their end surfaces and both ends of weld beads being sealed. In more detail, two hours of salt spray (5% NaCl aqueous solution) at 35° C., four hours of drying (humidity 25%) at 60° C., and two hours of wetting (humidity 95%) at 50° C. were set as one cycle, and after 60 cycles passed, a red rust generation state was evaluated as follows.

A rust generation area ratio was calculated in the flat portion of each of the welded joints, and the evaluation was conducted based on the following evaluation criteria. Score A and higher were considered passing.

### [Evaluation Criteria: Flat Portion]

score AAA: The red rust generation area ratio is 10% or less.
   AA: The red rust generation area ratio is over 10% and 25% or less.
   A: The red rust generation area ratio is over 25% and 40% or less.
   B: The red rust generation area ratio is over 40%.

Regarding the welded portions of the welded joints, the red rust generation states from toe portions of the weld beads were evaluated based on the following evaluation criteria. Score A and higher were considered passing.

### [Evaluation Criteria: Welded Portion]

score AAA: The width of the red rust from the toe portion is 2.0 mm or less.
   AA: The width of the red rust from the toe portion is over 2.0 mm and 4.0 mm or less.
      A: The width of the red rust from the toe portion is over 4.0 mm and 5.0 mm or less.
      B: The width of the red rust from the toe portion is over 5.0.

### <Adhesion Evaluation>

The obtained welded joints were immersed in salt warm water (3% NaCl aqueous solution, temperature 50° C.) for 500 hours, with their end surfaces and both ends of the weld beads being sealed. Thereafter, adhesive tapes (CT405AP manufactured by NICHIBAN Co., Ltd.) were pasted on the flat portions and the surfaces of the weld bead portions and thereafter peeled, and the areas of the coating films adhering to the tapes were measured. An area ratio of the peeled coating film to the entire area of the adhesive tape was calculated.

### [Evaluation Criteria: Flat Portion]

score AA: The area ratio of the peeled coating film is 20% or less.
   A: The area ratio of the peeled coating film is over 20% and 50% or less.
   B: The area ratio of the peeled coating film is over 50%.

### [Evaluation Criteria: Welded Portion]

score AA: The area ratio of the peeled coating film is 30% or less.
   A: The area ratio of the peeled coating film is over 30% and 60% or less.
   B: The area ratio of the peeled coating film is over 60%.

TABLE 2

| | EVALUATION RESULT | | | | | | | |
|---|---|---|---|---|---|---|---|---|
| | FLAT PORTION | | | | | | | |
| | | COLOR | | | WELDED PORTION | | | |
| | GLOSS | TONE | CORROSION | | WELDING | CORROSION | | |
| No. | Gs (60°) | L* | RESISTANCE | ADHESION | METHOD | RESISTANCE | ADHESION | CLASSIFICATION |
| 1 | A | A | A | A | LASER | A | A | EXAMPLE |
| 2 | A | A | AA | A | LASER | A | A | EXAMPLE |
| 3 | AA | AA | AA | A | LASER | AA | A | EXAMPLE |
| 4 | AA | AA | AA | A | LASER | AA | A | EXAMPLE |
| 5 | AAA | AA | AA | A | LASER | AAA | AA | EXAMPLE |
| 6 | AAA | AA | AAA | A | LASER | AAA | AA | EXAMPLE |
| 7 | AAA | AA | AAA | A | LASER | AAA | AA | EXAMPLE |
| 8 | AAA | AA | AA | A | LASER | AAA | AA | EXAMPLE |
| 9 | AAA | AA | AAA | A | LASER | AAA | AA | EXAMPLE |
| 10 | AAA | AA | AA | A | LASER | AAA | AA | EXAMPLE |
| 11 | AAA | AA | AAA | A | LASER | AAA | AA | EXAMPLE |
| 12 | AA | AA | AA | A | ARC | AA | A | EXAMPLE |
| 13 | AAA | AA | AAA | A | ARC | AAA | AA | EXAMPLE |
| 14 | B | B | A | A | LASER | B | B | COMPARATIVE |
| | | | | | | | | EXAMPLE |
| 15 | A | A | A | A | LASER | A | A | EXAMPLE |
| 16 | B | A | A | A | LASER | A | A | COMPARATIVE |
| | | | | | | | | EXAMPLE |
| 17 | B | A | A | A | LASER | A | A | COMPARATIVE |
| | | | | | | | | EXAMPLE |
| 18 | B | A | AA | A | LASER | A | A | COMPARATIVE |
| | | | | | | | | EXAMPLE |
| 19 | B | A | AA | A | LASER | A | A | COMPARATIVE |
| | | | | | | | | EXAMPLE |
| 20 | A | A | A | A | LASER | A | A | EXAMPLE |
| 21 | B | B | AA | A | LASER | B | B | COMPARATIVE |
| | | | | | | | | EXAMPLE |
| 22 | B | B | B | A | LASER | B | B | COMPARATIVE |
| | | | | | | | | EXAMPLE |
| 23 | AA | A | AA | B | LASER | A | A | COMPARATIVE |
| | | | | | | | | EXAMPLE |
| 24 | AA | A | AA | B | LASER | A | A | COMPARATIVE |
| | | | | | | | | EXAMPLE |
| 25 | AA | A | AA | B | LASER | A | A | COMPARATIVE |
| | | | | | | | | EXAMPLE |
| 26 | B | A | A | A | LASER | B | B | COMPARATIVE |
| | | | | | | | | EXAMPLE |
| 27 | B | A | A | A | LASER | B | B | COMPARATIVE |
| | | | | | | | | EXAMPLE |
| 28 | AA | A | AA | A | LASER | A | A | EXAMPLE |
| 29 | A | A | AA | AA | LASER | A | A | EXAMPLE |
| 30 | AAA | AA | AA | A | LASER | AAA | AA | EXAMPLE |
| 31 | B | A | AA | A | LASER | B | A | COMPARATIVE |
| | | | | | | | | EXAMPLE |
| 32 | A | A | A | A | LASER | AA | A | EXAMPLE |
| 33 | B | A | A | A | LASER | B | A | COMPARATIVE |
| | | | | | | | | EXAMPLE |

As is apparent from Table 2 above, it is seen that the welded joints using the samples corresponding to Examples of the present invention maintain excellent adhesion and further exhibit excellent glossiness and corrosion resistance, while the welded joints using the samples corresponding to Comparative Examples do not exhibit excellent adhesion or do not achieve both glossiness and corrosion resistance.

Hitherto, the preferred embodiments of the present invention have been described in detail with reference to the accompanying drawings, but the present invention is not limited to such examples. It is obvious that a person having ordinary knowledge in the technical field to which the present invention belongs could reach various changed examples or modified examples within the scope of the technical idea set forth in the claims, and it should be understood that these also belong to the technical scope of the present invention as a matter of course.

The embodiments disclosed herein are presented by way of example in all respects and are not restrictive. Various omissions, substitutions, and changes may be made in the above-described embodiments without departing from the scope of the accompanying claims and the later-described configuration and spirit belonging to the technical scope of the present invention. For example, the constituent elements of the above embodiments can be arbitrarily combined as long as the effects thereof are not impaired. From the arbitrary combination, the operations and effects brought about by the constituent elements involved in the combination can be obtained as a matter of course, and other operations and other effects obvious to those skilled in the art from the description of this specification are obtained.

Further, the effects described in this specification are merely explanatory or illustrative and are not restrictive. In other words, the technique relating to the present invention achieves other effects that are obvious to those skilled in the art from the description of this specification, in addition to or in place of the above effects.

### EXPLANATION OF CODES

1 surface-treated steel sheet
10 base steel sheet
20 galva-annealed layer
30 surface-treating layer
301 base resin
303 SiO₂-coated Al flake

1. A surface-treated steel sheet comprising:
a galva-annealed steel sheet having a steel sheet serving as a base material and a galva-annealed layer on the steel sheet; and
a surface-treating layer on the galva-annealed layer, wherein:
the surface-treating layer contains a base resin and SiO₂-coated Al flakes which are Al flakes each having a surface coated with a SiO₂ layer;
an average thickness of the SiO₂ layers is 10 to 100 nm;
an average particle size R of the SiO₂-coated Al flakes is 1.00 to 30.00 μm, and a ratio (R/t) of the average particle size to an average thickness t of the SiO₂-coated Al flakes is 10 or more; and
a coverage by the SiO₂-coated Al flakes on a surface of the galva-annealed steel sheet is 20% or more,
the coverage being a value given by the following equation:
$$coverage [ \% ] = ( \sum Ln / {L}_{0} ) \times 100 , \qquad equation ( 1 )$$
where, when a cross section of the surface-treating layer, the galva-annealed layer, and the steel sheet taken along a thickness direction is observed with a scanning electron microscope, L₀ is a dimension of a viewing field in a direction orthogonal to the thickness direction, and Σ Ln is a presence length of the SiO₂-coated Al flakes present in the viewing field.

2. The surface-treated steel sheet according to claim 1, wherein the surface-treating layer has an Al content of 0.15 to 12.00 g/m².

3. The surface-treated steel sheet according to claim 1, wherein the galva-annealed layer has a surface roughness of 1.0 to 10.0 μm.

4. The surface-treated steel sheet according to claim 1, wherein the surface-treating layer has an average thickness of 1.0 to 10.0 μm.

5. The surface-treated steel sheet according to claim 1, wherein the average particle size R of the SiO₂-coated Al flakes is 10.00 to 30.00 μm,

6. The surface-treated steel sheet according to claim 1, wherein a ratio (R_{L}/R_{S}) is 1.0 to 5.0, where Rₛ is a minor axis and R_{L} is a major axis of each of the SiO₂-coated Al flakes in plan view of the SiO₂-coated Al flake seen from a thickness-direction upper side of the SiO₂-coated Al flake.

7. The surface-treated steel sheet according to claim 1, wherein the coverage is 50% or more.
